(19) United States
(12) Patent Application Publication
(10) Pub. No.: US 2017/0249739 A1
(43) Pub. Date: Aug. 31, 2017

(54) COMPUTER ANALYSIS OF MAMMOGRAMS

(71) Applicant: BIOMEDIQ A/S, Copenhagen (DK)

(72) Inventors: Michiel KALLENBERG, Nijmegen (NL); Mads NIELSEN, Dragør (DK); Martin LILLHOLM, Niva (DK)

(73) Assignee: BIOMEDIQ A/S, Copenhagen (DK)

(21) Appl. No.: 15/054,839

(22) Filed: Feb. 26, 2016

(51) Int. Cl. G06T 7/00; G06K 9/66; G06K 9/62

(52) U.S. Cl. CPC G06T 7/0014; G06K 9/627; G06K 9/66; G06T 2207/10116; G06T 2207/30096; G06T 2207/30068

(57) ABSTRACT

A method of screening a population of women for breast cancer by mammography, comprising establishing a screening schedule, conducting a screening mammography on a patient in accordance with said screening schedule to obtain a mammogram image, determining whether a cancer lesion is visually observable in said mammogram image, in the event that no cancer lesion is visually observable in said mammogram image conducting a computer image analysis of the mammogram image in which no potential cancer lesion is visually observable, said method serving to determine the risk of there being such a lesion physically present or about to arise within a screening interval, said method comprising applying to the image a statistical classifier trained to score on the basis of texture features in the image that reflect such risk.

The present invention relates to the field of computer analysis of mammograms and is useful in breast cancer screening. It provides an improvement in the technical field of breast cancer diagnostics.

Breast cancer is the most frequently diagnosed cancer among women, worldwide [1]. In 2012, 464,000 new cases (13.5% of all cancers) were diagnosed in Europe and 131,000 died from the disease [2]. Breast cancer mortality can be reduced by identifying high risk patients early and treating them adequately [3]. One of the strongest known risk factors for breast cancer after gender, age, gene mutations, and family history is the relative amount of radiodense tissue in the breast, expressed as mammographic density (MD). According to several studies, women with high MD have a two to six-fold increased breast cancer risk compared to women with low MD [4], [5]. Further, breast density is modifiable and density changes relate to breast cancer risk. Tamoxifen, for example, reduces breast density and decreases the risk, whereas hormone replacement therapy causes the opposite [6].

Many MD scores have been proposed, ranging from manual categorical (e.g. BI-RADS) to automated continuous scores. In early years, radiologists characterized the mammographic appearance by a set of intuitive, but loosely defined breast tissue patterns that were shown to relate to the risk of breast cancer [7], [8]. The current gold standard is semi-automated continuous scores, as obtained by Cumulus-like thresholding [9]. In Cumulus, the radiologist sets an intensity threshold to separate radiodense (white appearing) from fatty (dark appearing) tissue. The computer then measures the proportion of dense to total breast area, known as percentage mammographic density (PMD). However, user-assisted thresholding is subjective and time-consuming, and hence not suited for large epidemiological studies. There has been a trend towards fully automating PMD scoring [10], [11], [12], [13], [14], [15], but most of these approaches rely on handcrafted features with several parameters that need to be controlled. Generalizing these methods beyond the reported datasets could be challenging.

Finding features that capture the relevant information in the mammogram is a difficult task. This becomes even more apparent when looking at work on mammographic texture (MT) scoring. MT scoring methods traditionally aim to find breast tissue patterns (or textures) that are predictive of breast cancer risk [16], [17], [18], [19], [20], [21], [22]. Intuitively, their goal is to characterize breast heterogeneity instead of breast density. MT scoring is even harder than MD scoring, since the label of interest (healthy vs. diseased) is defined per image and not per pixel (e.g. fatty vs. dense). Previous work on MT scoring has focused on manually designing and selecting features, similar to automatic MD scoring methods [17], [18], [19], [20].

In most developed countries, women undergo regular screening for breast cancer using mammography. Typically, women from ages 50 to 70 are screened every 1-3 years. In some countries normal screening starts as early as 40 and in other countries it continues until 80.

It is well established [68] that for women with increased mammographic density (MD), the sensitivity of mammography is impaired. The radiodense tissue can mask or occlude the cancers. As such it has been proposed to estimate the amount of fibroglandular tissue in the breast as an indicator for the risk of false negative screening examinations as some breast cancers are missed by radiologists when they read mammograms. Some cancers are missed simply due to radiologist error while others are missed because they are very difficult or impossible to diagnose using mammography. The present invention addresses this category.

Interval (I) cancers are defined as cancers that are diagnosed in-between ordinary screening visits. Typically, woman discovers them on their own through self-palpation, pain, or other symptoms. They are then fully diagnosed using diagnostic mammography, ultra-sound, MRI, and/or biopsy. Conversely, standard or screen-detected (SD) cancers are diagnosed during routine screening mammography.

The three primary causes of interval cancers are 1) rapidly growing cancers that develop and manifest between screening rounds, 2) cancers missed at screening due to human error and 3) cancers missed during screening due to masking/occlusion by dense tissue. The distinction between 1 and 3, and between 2 and 3 are of course not always well defined.

The present invention now provides in a first aspect a method of computer image analysis of a mammogram image in which no potential cancer lesion is visually observable, said method serving to determine the risk of there being such a lesion physically present or about to arise within a screening interval, said method comprising applying to the image a statistical classifier trained to score on the basis of texture features in the image that reflect such risk.

Optionally, the classifier has been trained to discriminate between (a) mammogram images in which no potential cancer lesion is visually observable which belong to patients who go on to remain free from breast cancer over a period after their said mammogram image was obtained, and (b) mammogram images in which no potential cancer lesion is visually observable which belong to patients who are later diagnosed with breast cancer within a similar period.

It may be that the cancer diagnosis relating to the images in group (b) has been based on the detection of interval cancers.

It may alternatively be that the cancer diagnosis relating to the images in group (b) has been based on the detection of cancer in a subsequent regular screening mammogram.

It may alternatively be that the cancer diagnosis relating to the images in group (b) has been based on the detection of cancer in some cases based on the detection of interval cancers and in some cases in a subsequent regular screening mammogram.

Optionally the classifier has been trained to discriminate between (a) mammogram images in which no potential cancer lesion is visually observable which belong to patients who go on to be diagnosed with breast cancer at a subsequent regular mammogram screening, and (b) mammogram images in which no potential cancer lesion is visually observable which belong to patients who are later diagnosed with an interval breast cancer.

Optionally the classifier has been trained to discriminate between (a) mammogram images in which no potential cancer lesion is visually observable which belong to patients who have been subject to further investigation by more sensitive detection methods than mammogram screening without any breast cancer being observed, and (b) mammogram images in which no potential cancer lesion is visually observable which belong to patients who have been subject to further investigation by more sensitive detection methods than mammogram screening with the result that a breast cancer has then been observed.

Optionally in any of the above training scenarios, to apply the classifier to the mammogram image, a feature representation based on texture features is extracted from the image, said feature representation having been learnt in the training of the classifier.

The classifier may be a neural network having at least two convolutional layers and the classifier may have a multinomial logistic regression further layer which maps a said feature representation obtained in the last of the at least two convolutional layers into label space.

It may be that the feature representation has been learnt by learning respective feature representations in said convolutional layers by unsupervised learning using a sparse autoencoder combining population sparsity and lifetime sparsity as a sparsity regulariser and by encoding said features to learn a sparse overcomplete feature representation of the training images.

It may be that wherein said training images are labelled as cancer or control.

The invention further includes a method of computer image analysis of a mammogram image in which no potential cancer lesion is visually observable, wherein a composite measure of the risk of there being a lesion physically present despite no potential cancer lesion being visually observable in said mammogram image is obtained by combining the risk of there being such a lesion physically present determined by any method described above with a measure of risk based on mammographic density scoring of the mammogram.

To obtain said measure of risk based on mammographic density scoring of the mammogram a trained classifier may have been applied to the mammogram.

The classifier for obtaining a risk measure based on mammographic density may operate in a similar manner to the classifier used for determining texture based risk. Thus, to apply the classifier to the mammogram image, a feature representation based on density features may be extracted from the image, said feature representation having been learnt in the training of the classifier.

The classifier for obtaining a risk measure based on mammographic density may likewise be a neural network having at least two convolutional layers. Optionally, this classifier has a multinomial logistic regression further layer which maps a said feature representation obtained in the last of the at least two convolutional layers into label space.

Similarly, it is optional that this feature representation has been learnt by learning respective feature representations in said convolutional layers by unsupervised learning using a sparse autoencoder combining population sparsity and lifetime sparsity as a sparsity regulariser and by encoding said features to learn a sparse overcomplete feature representation of the training images.

Pixels of said training images may have been labelled as fatty tissue or dense tissue.

Methods of the invention may further comprise outputting a determined risk of there being a cancer lesion physically present or about to arise within a screening interval.

Alternatively, based on the determined risk, the output may take the form of a recommendation for further screening or treatment of the patient.

The invention includes a method of screening a population of women for breast cancer by mammography, comprising establishing a screening schedule, conducting a screening mammography on a patient in accordance with said screening schedule to obtain a mammogram image, determining whether a cancer lesion is visually observable in said mammogram image, in the event that no cancer lesion is visually observable in said mammogram image conducting a computer image analysis of the mammogram image in which no potential cancer lesion is visually observable, said method serving to determine the risk of there being such a lesion physically present or about to arise within a screening interval, said method comprising applying to the image a statistical classifier trained to score on the basis of texture features in the image that reflect such risk. The risk so determined may be combined with risk determined on the basis of mammographic density as described above.

More generally, said computer image analysis may be conducted in accordance with any of the methodology described above.

Consequent upon said risk determination, the method may further comprise conducting a further imaging diagnostic investigation of said patient if the determined risk is above a predetermined threshold.

Consequent upon said risk determination, the method may further comprise scheduling a further mammogram investigation of said patient in advance of a date for a further mammogram investigation indicated by said screening schedule.

The invention includes a non-transitory computer readable medium encoded with an instruction set for receiving mammogram image data relating to a mammogram in which no cancer lesion is visually observable and conducting a computer image analysis thereof in accordance with a method described above and outputting a determined risk of there being a cancer lesion physically present or about to arise within a screening interval.

The invention includes also a computer comprising a non-transitory computer readable medium encoded with an instruction set for receiving mammogram image data relating to a mammogram in which no cancer lesion is visually observable and conducting a computer image analysis thereof in accordance with a method as described above and outputting a determined risk of there being a cancer lesion physically present or about to arise within a screening interval.

By the use of the invention, women who have a negative screening mammogram but who have a higher than normal risk of having either a cancer not seen in the mammogram or of having a cancer appearing in their next routine screening mammogram can be identified. They can then be further investigated, suitably by the use of a more sensitive imaging methodology. The application of such more sensitive methodologies to all women to be screened would not only involve excessive expense but it would be likely to generate excessive false positives, leading to unnecessary further procedures and distress.

In the following description of illustrative embodiments of the invention, reference is made to the following drawings:

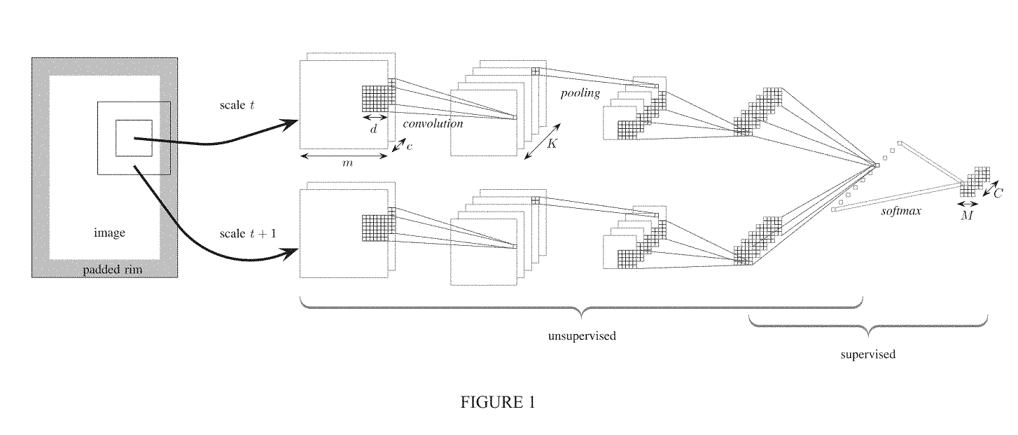

FIG. 1 shows deep convolutional architecture consisting of convolutional, pooling and softmax layers;

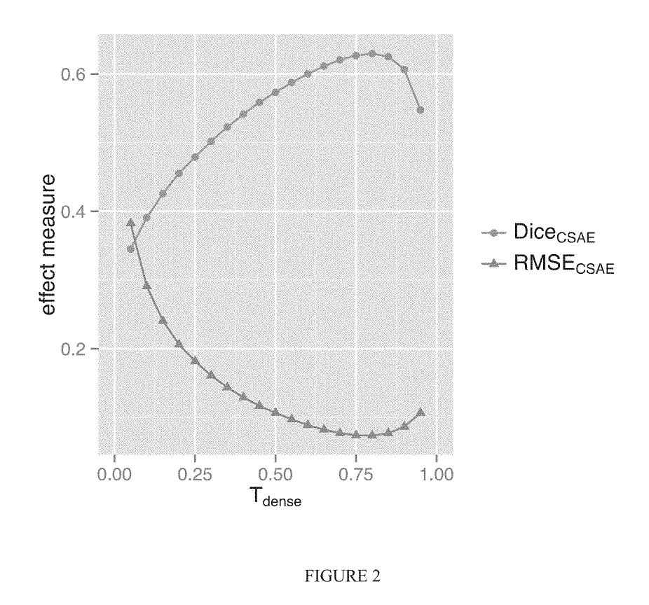

FIG. 2 shows the effect of varying the threshold on the posteriors Tdense on two performance measures of MD scoring, namely (i) the image-wise average of the Dice coefficient, and (ii) the root mean squared error between the percent density (PMD) as measured by the invention machinery and the radiologist as determined in the Example below:

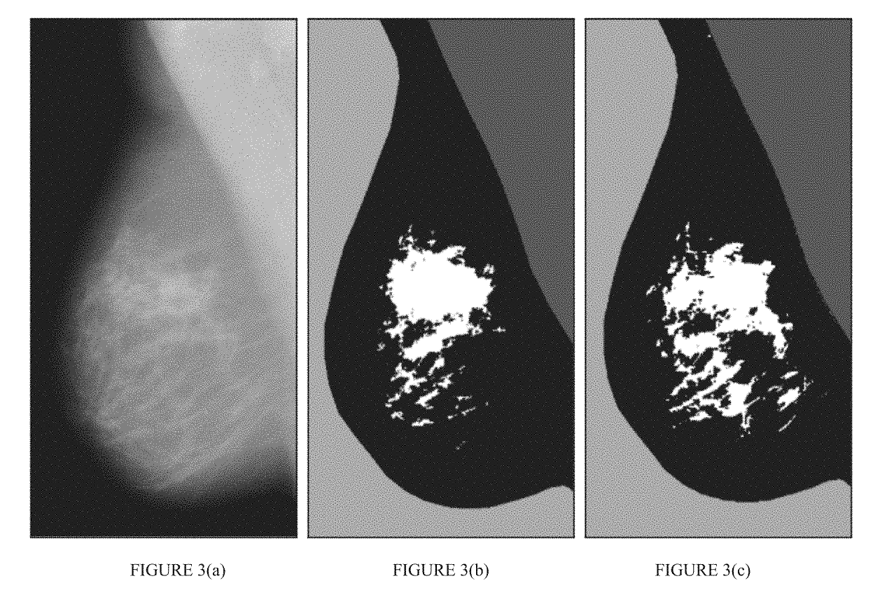

FIGS. 3(a)-3(c) show the result of automated MD thresholding. Depicted are (a) original image, (b) dense tissue according to expert Cumulus-like threshold, and (c) dense tissue according to CSAE;

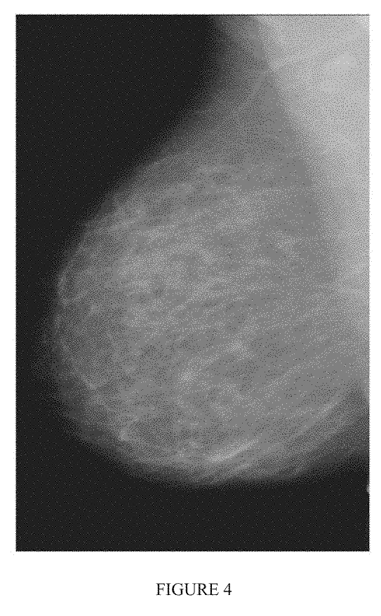

FIG. 4 shows an example of a mammogram with high textural masking risk and low density masking risk.

In the following, we shall treat the risk of having an interval cancer as a good surrogate for the risk of having a cancer that will be missed during standard screening.

As mentioned above, it is well established that MD is positively associated with the risk of masking: a breast with large amounts of dense tissue has higher masking potential. In the limit, a homogeneously dense breast presents as opaque white in the mammogram and it is very difficult to use for diagnostic purposes—potential cancers are occluded by the dominating radio-dense tissue.

The present invention deals with the phenomenon that the spatial distribution of even relatively small amounts of dense tissue equally can mask cancers. The mammographic manifestation of the lesion is camouflaged by similar looking tissue; in contrast to the MD driven masking were the lesion is occluded per se.

Several authors have published works on mammographic texture analysis. The objective of these works were mostly prediction of the risk that a woman will develop breast cancer, irrespective of whether the cancer is detected by mammography screening or clinically diagnosed. Our aim is to predict whether a woman will develop a cancer that is being missed in regular screening and we believe that MD alone is a sub-optimal descriptor, as a developing breast cancer may not only be missed because it is obscured by fibroglandular tissue; it may also be missed because its mammographic signs resemble the textural structure of normal tissue. As such we believe that a measure that covers the more structural aspects of mammographic fibroglandular texture potentially better predicts or at least supplements MD when estimating the risk on false negative screening exams.

The methods according to preferred aspects of the invention described below automatically learn relevant features of images, more specifically mammograms. The feature learning system employed in these methods is a convolutional sparse autoencoder (CSAE), as its core consists of a sparse autoencoder within a convolutional architecture. The method extends previous work on CSAEs [23], [24] to the problem of pixel-wise labeling and to large images (instead of small patches), the difference in size of image typically being several hundred fold in terms of pixel numbers. By extracting patches of limited size, for instance 25×25, on several spatial scales the preferred methods described herein in principle can cover both fine detail and the full image context. The CSAE employed herein is generic, easy to apply, and requires barely any prior knowledge about the problem. The main idea of the model is to learn a deep hierarchy of increasingly more abstract features from unlabeled data. Once the features have been learned, a classifier is trained to map the features to the labels of interest.

In order to more fully describe and illustrate the invention by way of an example, we now describe applying a method preferred method of the invention to two breast-cancer tasks: The first task is the automated segmentation of breast density (MD). The second task is to characterize mammographic textural (MT) patterns with the goal of predicting the risk that a woman has or will develop a breast cancer that will not be detected during regular screening mammography—whether they are masked, missed, or cancers that are yet to appear even on more sensitive imaging and which may be rapidly growing cancers that will be picked up on a subsequent screening mammogram.

As in previous work on multiscale denoising autoencoders [25], [26], the method described herein analyzes features at multiple scales. Further, the CSAE employs a convolutional architecture that models the topology of images, and integrates a novel sparsity term to control the model capacity. In contrast to previous work, this does not handpick heuristic texture features, but instead aims to learn meaningful texture features directly from the unlabeled mammograms. The uncommitted method is better suited to generalize to different datasets.

A lot of research has been devoted to selecting and handcrafting features that encode the important factors of variation in the input data. However, it can be time-consuming and tedious to mathematically describe human intuition and domain-specific knowledge. Furthermore, human heuristics are not guaranteed to capture the salient information of the data, and features that perform well on a related computer vision problem (a field from which many of these techniques derive) may not transfer to the task at hand.

An increasing number of papers demonstrate that comparable or even better results are achieved by learning features directly from the data. Especially deep nonlinear models have been proven to generate descriptors that are extremely effective in object recognition and localization in natural images. A recent overview of feature learning with deep models is given in [35] and [36]. Inspired by the human brain, these architectures first learn simple concepts (or features) and then compose them to more complex ones in deeper layers. In addition, features share components from lower layers which allow them to compactly express the idiosyncrasies of the data and fight the curse of dimensionality [37]. Most of these models are trained by iteratively encoding features (forward propagation) and updating the learned weights to improve the optimization (backward propagation).

One approach is to jointly optimize the features of the deep model, in order to minimize the loss between the predictions of the top most layer and the target values. Traditional neural networks fall into this category, and also variants like convolutional neural networks (CNNs) by Lecun et al. [38], which are tailored towards images. Deep neural networks, such as CNNs, have been successfully applied to challenging image analysis problems, e.g., object recognition, scene parsing [39], cell segmentation [40], neural circuit segmentation [41], [42], and analysis of images the breast [43], [44], [45], [46]. They were found to be faster and more expressive than other graphical models like Markov or Conditional Random Fields [47].

The features can also be learned in an unsupervised way, e.g. using Restricted Boltzmann Machines [48], [49] or autoencoders [23], [50], [51]. The features are typically learned in a greedy, layer-wise fashion, before a classifier is trained to predict the labels from the feature responses of the top most layer. The division into multiple optimization problems has several advantages. First, large amounts of unlabelled data can be exploited for training the features. Second, the features are learned faster and in a more stable manner, as each layer is optimized by a small encoder-decoder architecture instead of a complex deep network. Thirdly, these deep models can incorporate transformations and classifiers that are optimized independently from the features.

In the preferred method described below, a sparse autoencoder is employed for learning the features in an unsupervised way. Previous work has suggested sparse autoencoders for object recognition from small image patches [23], [24], [52]. In contrast, we propose a feature learning method for mammograms, which are large images, that exploits information at multiple scales and incorporates a different sparsity regularizer to enable the shift to handling large images. The use of multiple scales adds the ability to handle both fine detail and large scale image interactions in the same framework, initially, as one pipeline per scale and then fused in supervised final layers.

The overall approach consisting of three parts: generating input data, model representation, and parameter learning employed in this example will now be described. The input data is composed of multiscale image patches that capture both detail and large contextual regions. The patches are processed by a multilayer convolutional architecture. The parameters of this representation are learned using a sparse autoencoder, which enhances the standard autoencoder with a novel sparsity regularizer.

Assume a set of training images (mammograms) with associated label masks and the goal of predicting the label mask for an unseen image. It would be computationally prohibitive to map entire images to label masks. Downsampling the image is also infeasible, as many structures of interest occur at a fine scale. However, we can learn a compact representation for local neighbors (or patches) from the image.

Let us represent the labels in a 1-of-C coding scheme. Then formally, we aim to map a multi-channel image patch xεX=R^{c×m×m} of size m×m with c channels to a label posterior patchy yεY=R^{C×M×M} of size M×M with one channel per label, where quadratic input sizes are assumed for ease of notation. The image and label posterior patch are centered at the same location, but can have different sizes. The channels of the image patch may include color channels, pre-processed image patches, or feature responses.

For training the model, n labelled training examples D={(x^{[i]},y^{[i]})}ⁿᵢ₌₁ are extracted at randomly chosen locations across the set of training images. Given the training data D, the model learns a hypothesis function h:X→Y which is parameterized by θ.

The hypothesis function h is here defined as a latent variable model that consists of multiple layers. Instead of mapping x to y directly, a series of increasingly more abstract feature representations z^{(l)} for layers lε1, . . . , L, are learnt where z⁽¹⁾=x and z^{(L)}εY. The terms weights and features are used here interchangeably to refer to the parameters of a representation transformation. The output of this transformation are called activations or feature representation. Within a convolutional architecture, the activations will be spatially arranged as feature maps. The feature representations are gained by encoding the input through a cascade of transformations, of which some are trainable. The parameters of these transformations are learnt in a greedy layer-wise fashion without using the labels. The initial layers based on autoencoders are unsupervised. This means that they optimize towards being able to reconstruct “generic” mammogram patches without using cancer labels information. Only the later supervised layers use either cancer/control or dense/fatty labels. While an individual layer is not deep, the stacked architecture is (e.g. the second layer receives as input the output from the first layer). Thus, the individual unsupervised training of (shallow) layers results in an unsupervised deep learning procedure.

Three steps are used to move from one feature representation, z^{(l)}, to the next one, z^{(l+1)}:
1. Extract sub-patches (called local receptive fields) from random locations in z^{(l)} and optionally preprocess them.
2. Feature learning: Learn transformation parameters (or features) by autoencoding the local receptive fields.
3. Feature encoding: Transform all local receptive fields in z^{(l)} using the learned features from step 2. The result of the transformation is referred to as the feature representation z^{(l+1)}.

A classifier maps the last feature representation into label space Y. An unseen image is tested by applying the trained hypothesis function h_{θ}(x) to all possible patches in a sliding window approach. Thus, every patch within the tested image is sent through the trained encoders and classifier to create a prediction. If the size of the predicted output region is bigger than a single pixel, i.e., M>1, predictions at neighboring image locations might overlap with each other. These predictions can be fused by computing the average probability per class.

An overview of the pipeline is shown in FIG. 1. The architecture consists of four hidden layers: a convolutional layer, a maximum pooling layer, and two further convolutional layers. One pooling layer is chosen to be invariant towards small distortions, but sensitive to fine-scaled structures. Further specifics of this will described below.

Long range interactions in the mammograms are captured by extracting input examples x from multiple scales. As introduced in previous work [25], [26], a given mammogram I is embedded into a Gaussian scale space

I(u;σₜ)=[I*G_{σt}](u).

Here the * operator denotes convolution. Multi-scale mammographic analysis is realized using the well established discrete scale space theory (see, e.g., [53]); specifically, a Fourier implementation is used where the Gaussian kernel is discretized in the Fourier domain and spatial convolution obtained through multiplication (in the Fourier domain) with the discrete Fourier transform of the mammogram [54]. The parameter sεR² denotes the position (or site) and σₜ determines the standard deviation of the Gaussian at the tth scale. More specifically, the standard deviation

$${σ}_{t} = \sqrt{{\sum }_{i = 0}^{t - 1} {δ}^{2 i}} \qquad ( 1 )$$

is given as the square root of the summed Gaussian variances from the first t scale levels of the Gaussian pyramid. In this example, downsampling factor δ is chosen to be 2.

An input example xt at location u from scale t is constructed by sampling a patch with pixel distance (or stride) δ^{t-1} around location u in the Gaussian scale space.

For example, an input patch at scale level t=1 is a coherent m×m region, whereas the patch at scale t=4 considers only every eighth pixel around u from a heavily smoothed mammogram. The underlying representation of the model, a convolutional architecture, processes inputs from multiple scales. This architecture is illustrated in FIG. 1 which shows deep convolutional architecture consisting of convolutional, pooling and softmax layers. As illustrated, input patches are extracted from multiple scales of an image. The pixel spacing of the patches is adjusted such that the feature maps at different scale levels are equally sized. Each scale level of the CSAE model is processed in isolation before all activations are integrated in the second last layer. The convolutional layers in the unsupervised parts are trained as autoencoders; In the supervised part the (pretrained) weights and bias terms are fine-tuned using softmax regression. For computational reasons, features are first learned for each scale in isolation, before they are merged in deeper layers.

It would be possible to learn the weights (or features) using forward and backward propagation through the entire architecture [38]. However, the aim here is to learn features in an unsupervised way using autoencoders. A variant of the autoencoder is accordingly proposed that enables to learn a sparse overcomplete representation. A feature representation is called overcomplete if it is larger than the input. Sparsity forces most of the entries to be zero, leaving only a small number of non-zero entries to represent the input signal. Thus, in the case of extreme sparsity, each input example would be encoded by a single hidden unit, the one whose input weights (or feature) are the most similar to the input example.

Sparse overcomplete representations provide simple interpretations, are cost-efficient, and robust to noise. They are suited to disentangle the underlying factors of variation because each input example needs to be represented by the combination of a few (specialized) features.

In previous work, feature representations have been made sparse by limiting the number of active (non-zero) units per example (population sparsity) or by limiting the number of examples for which a specific unit is active (lifetime sparsity). Population sparsity underlies methods like sparse coding [55], or K-means, where each cluster centroid can be interpreted as a feature and each example is encoded by the most similar centroid. Lifetime-sparsity is incorporated in the sparsifying logistic by Ranzato et al. [23] or the sparse RBM by Lee et al. [56], where the average activation per unit is supposed to equal a user-specified sparsity threshold.

In this embodiment, a sparsity regularizer is formulated that incorporates both population sparsity and lifetime sparsity. While population sparsity enforces a compact encoding per example, lifetime sparsity leads to example-specific features. The proposed sparsity prior can be combined with any activation function including the rectified linear function, which was shown to produce better features than the sigmoid or the hyperbolic tangent in [57]. The formalization of the sparse autoencoder will now be described

Consider learning the weights wjεR^{c×d×d} in for j=1, . . . , K, where the layer index is omitted for brevity. Rewriting the K 3D weight arrays as a weight matrix gives W εR^{K×cd}^{²}, where the jth row corresponds to wⱼ. Similarly, the bias vector bεR^{K} concatenates the K bias terms bⱼ. Assuming further that there has been sampling of one local receptive field at a random location per input feature map example z^{[i]}εR^{c×m×m} with i=1, . . . , n. if the local receptive fields have a size of c×d×d, but are arranged as vectors r^{[i]}εR^{cd}^{²}, where i=1, . . . , n and d≦m, then, W and b can be learnt in an unsupervised way by autoencoding the local receptive fields.

The autoencoder reconstructs an input rεR^{cd}^{²} composition f(g(r)) of an encoder g(·) and a decoder by a f(·). The encoder

a≡g(r)=φ(Wr+b) (2)

connects the input layer with the hidden layer and uses the activation function φ(·), which is commonly one of the following: the sigmoid, the hyperbolic tangent, or the recently introduced rectified linear function φ(x)=max(0,x) that is used in this example due to its reported superior performance [57]. The decoder

f(a)=ψ(Va+\tilde{b}) (3)

is an affine mapping between the hidden layer and the output layer. The activation function of the decoder ψ(·) is usually set to the identity function and the weight matrix V=W^{T} is defined as the transpose of the encoder weight matrix (i.e., tied weights are used [66]). The bias of the decoder \tilde{b}εR^{cd}^{²} has the same dimension as the input. Tying the weights of the encoder and decoder encourages V and W to be at the same scale and orthogonal to each other [67]. It also decreases the number of trainable parameters and thereby improves the numerical stability of the algorithm. The specialized decoder is thus given by f (a)=W^{T}a+\tilde{b}.

Denote the set of training examples as Drec={r^{[i]}}^{N}ᵢ₌₁ and the trainable parameters as θ_{rec}={W, b, \tilde{b}}. Then the objective function to be minimized is

$${𝒥}_{AE} ( {𝒟}_{rec} , {θ}_{rec} ) = \frac{1}{n} {\sum }_{i = 1}^{n} {ℒ}_{rec} [ {e}^{[ i ]} , f ( g ( {r}^{[ i ]} ) ) ] , \qquad ( 4 )$$

where the reconstruction error

L_{rec}[r^{[i]},f(g(r^{[i]}))]=∥r^{[i]}−f(g(r^{[i]})))∥² (5)

is the squared loss. To avoid that the autoencoder learns the identity function, the hidden layer is constrained to be undercomplete, i.e., the number of hidden units is smaller than the number of input units (K<cd²).

Define a sparse autoencoder that minimizes the objective function

$${𝒥}_{SAE} ( {𝒟}_{rec} , {θ}_{rec} ) = \frac{1}{n} {\sum }_{i = 1}^{n} {ℒ}_{rec} [ {r}^{[ i ]} , f ( g ( {r}^{[ i ]} ) ) ] + {λω}_{sp} ( A ) \qquad ( 6 )$$

using the novel sparsity term

ωₛₚ(A)=ωₚₛₚ(A)+ωᵢₛₚ(A). (7)

This regularizer combines population sparsity ωₚₛₚ(A) and lifetime sparsity ωᵢₛₚ(A) with respect to the activation matrix AεR^{K×n}, Aⱼᵢ=aⱼ^{[i]}=g(rⱼ^{[i]}).

To define the population sparsity term, compute the average absolute activation for the jth activation unit (averaged across the n examples)

$$\begin{matrix}{\hat{ρ}}_{j} = \frac{1}{n} {\sum }_{i = 1}^{n} \vert {A}_{ji} \vert \\ = {n}^{- 1} \vert \vert {A}_{j .} {\vert \vert}_{1} ,\end{matrix} \qquad ( 8 )$$

where ∥Aⱼ.∥₁ is the L₁-norm of the jth row in A. Compare this unit-wise population sparsity to a pre-specified sparsity parameter ρ

$${ω}_{psp} ( A ) = \frac{1}{K} {\sum }_{j = 1}^{K} {τ ( {\hat{ρ}}_{j} ; ρ )}^{2} \qquad ( 9 )$$

and average the squared thresholded difference over the K units. Here, the threshold function

τ(\hat{ρ};ρ)=max(ρ−ρ,0). (10)

penalizes sparsity values above ρ to avoid non-specific features. Values below ρ are not punished because selective features shall be permitted. A typical value for the sparsity level is ρ=0.01 (see the description below of parameter settings and model selection).

Specify the lifetime sparsity for the ith example as its average absolute activation averaged across the K activation units

$$\begin{matrix}{\hat{ρ}}^{( i )} = \frac{1}{K} {\sum }_{j = 1}^{K} \vert {A}_{ji} \vert \\ = {K}^{- 1} \vert \vert {A}_{. i} {\vert \vert}_{1} ,\end{matrix} \qquad ( 11 )$$

where ∥A.ᵢ∥₁ is the Lᵢ-norm of the ith column in A. The total lifetime sparsity is then given by

$${ω}_{lsp} ( A ) = \frac{1}{n} {\sum }_{i = 1}^{n} {τ ( {\hat{ρ}}^{[ i ]} ; ρ )}^{2} . \qquad ( 12 )$$

FIG. 1 shows in panel (a) an autoencoder for learning the features of the convolutional layer. The input is vectorized and reconstructed by an encoder-decoder architecture. Panel (b) shows inference in a convolutional layer using a 3D convolution. The encoded units correspond to the highlighted units in output z(l+1) of the convolutional layer. The weights wj between input feature maps z(l) and the jth output feature map are marked in red and initialized with the learned weights from the autoencoder.

### EXAMPLE

### Density Dataset and Experiments

From the Dutch breast cancer screening program, were collected 493 mammograms of healthy women. Mean age of the women was 60.25±7.83 years. The images were recorded between 2003 and 2012 on a Hologic Selenia FFDM system, using standard clinical settings. The raw image data was used. The set contained a mixture of mediolateral oblique (MLO) and craniocaudal (CC) views from the left and right breast. For each woman however only one view was available.

A trained radiologist annotated the skin-air boundary and the pectoral muscle by a polygon tool. In a second step, the breast tissue area was delineated by cropping superfluous tissue folds below and above the breast area. The radiologist estimated percent density using a Cumulus like approach. A secondary outcome of the Cumulus like annotation, is that for each image breast tissue pixels are labelled as either dense or fatty. The pixels and their labels form the training data for the CSAE pipeline and the extent to which the resulting pixel classification can reproduce the dense tissue segmentation is evaluated using 5-fold cross-validation.

### Dutch Breast Cancer Screening Dataset and Experiments

From the Dutch breast cancer screening program, were collected 394 cancers, and 1182 healthy controls. 285 of the cancers were screen detected and 109 were interval cancers. Controls were matched on age and acquisition date. The images were recorded between 2003 and 2012 on a Hologic Selenia FFDM system, using standard clinical settings. For each woman MLO views from both the right and left breast were available. However, to exclude signs of cancerous tissue, the contralateral mammograms were taken for the present analyses. The raw image data was used. Mean age of the women was 60.6±7.70 years.

For this dataset, training was done using different three training setups. For each setup or regime, training was done on priors (i.e. screening mammograms from one or more screening rounds before the cancer occurred), or, if a prior is not available, the contralateral breast:

i) Healthy Controls Vs. (Screen Detected+Interval Cancers)—H Vs (SD+I):
The risk scores obtained with such a training regime are predictive of the risk that a woman will develop breast cancer. This is often referred to as breast cancer risk. In the context of masking, we evaluate whether the textural patterns trained for cancer risk per se also relate to the risk of developing breast that is not detected in regular mammography screening.

ii) Healthy Controls Vs. Interval Cancers—H Vs I:
the risk scores obtained with such a training regime are predictive of the risk that a woman will develop breast cancer that is not detected in regular mammography screening—whether camouflaged/masked or missed or actually absent at the time of screening but which came about rapidly later.

iii) Screen Detected Cancers Vs Interval Cancers—SD Vs I:
The risk scores obtained with such a training regime are predictive of the risk that a tumor will not be detected in regular mammography screening—whether camouflaged/masked or missed or actually absent at the time of screening but which came about rapidly later.

Before extracting the patches, the mammograms were resized to an image resolution of roughly 50 pixels per mm. The model was trained on n=48,000 patches. The patch size in terms of number of pixels was restricted to 24×24 in order to keep the number of trainable weights and bias terms limited. The training patches were sampled across the whole dataset as follows: For density scoring 10% of the patches were sampled from the background and the pectoral muscle, 45% from the fatty breast tissue, and 45% from the dense breast tissue. For scoring of textural masking risk the three training regimes were handled as follows: i) H vs (SD+I), 50% of the patches were sampled from the breast tissue of healthy controls, and 50% from the breast tissue of cancer cases—SD and I, ii) H vs I, 50% of the patches were sampled from the breast tissue of controls, and 50% from the breast tissue of the interval cancer cases, and iii) SD vs I, 50% of the patches were sampled from the breast tissue of the screen detected cancers, and 50% from the breast tissue of the interval cancer cases. In pilot experiments we experimented with different breast tissue masks to sample patches from. Best results were obtained if we restricted the sampling of the patches to the inner breast zone, which is the breast area that is fully compressed during image acquisition, and in which the fibroglandular tissue is most prominent. For both tasks M=1 was chosen. Scales t to were set 1 to 4 for both density and texture scoring. The smallest patch was thus 4.8 mm×4.8 mm, whereas the biggest patch was 3.7 cm×3.7 cm. As such several structures of interest could be captured in different detail. On a validation set we experimented with different setups of the input channels. Best results were obtained by having one input channel consisting of the unprocessed image.

For both example tasks, the number of feature maps were set to K={50, (50), 50, 100}; the associated kernel sizes were fixed to {7, 2, 5, 5}. These values were motivated from previous work on convolutional architectures [59].

To learn the weights of the convolutional layers, a sparse autoencoder was trained on N=48,000 extracted local receptive fields from the activations of the previous layer. For the first layer each local receptive field was pre-processed by removing its DC components. The sparsity parameter was set to ρ=0.01 and the weighting term of the sparsity regularizer to λ=1. The backpropagation algorithm was applied to compute the gradient of the objective function in (6). The parameters were optimized with L-BFGS using 25 mini-batches of size 2,000. Each mini-batch was used for 20 iterations, such that the entire optimization ran for 500 iterations. In pilot experiments the settings of the hyperparameters were determined. In these pilot experiments most emphasis was put on the sparsity regularizer λ and the length of the training for both the unsupervised and the supervised part of the network. It was found that the performance was robust for a broad range of values of the mentioned parameters.

As a classifier a two-layer neural network was trained. This consisted of a pre-trained convolutional layer (i.e., layer L−1) and multinomial logistic regression (or softmax classifier) layer. It can be seen in FIG. 1 that there is overlap between the unsupervised and supervised layers. That is, that the weights and bias terms of the pre-trained convolutional layer (i.e., layer L−1) are fine-tuned with a supervised signal. Alternatively put, the output of the final unsupervised layer is used to initialise the weights for the first supervised layer—these weights are then optimised towards task performance during training using the labels. In that sense the unsupervised and supervised parts share one set of weight “slots” but once the supervised part takes over the un-supervised layer does not play a role any longer. For MD scoring we utilized three class labels: (i) pectoral muscle and background, (ii) fatty tissue, and (iii) dense tissue. For MT scoring we had two class labels: (i) cancer, and (ii) control (suitable varied to reflect each of the three training regimes). The optimization was performed for 500 iterations using L-BFGS on the n encoded patches. Unless stated otherwise for each task and dataset results were obtained by performing 5-fold cross-validation by image to estimate the generalization ability of our machinery.

The initial output of the MD scoring is a score that represents the posterior probability that a given pixel belongs to the dense tissue class. By thresholding the posteriors with threshold T_{dense} a segmentation of the dense tissue is obtained. Percent density (PMD) is then computed as the percentage of breast pixels that is segmented as dense. To speed up training the dense class was oversampled during training. As such the machinery tends to overestimate the density if the threshold T_{dense} is set to 0.50. By raising T_{dense} this effect is compensated for.

FIG. 2 shows the effect of T_{dense} on two performance measures, namely (i) the image-wise average of the Dice coefficient, defined as 2|A∩B|/(|A|+|B|) between the automated segmentation A and the segmentation of the radiologist B, and (ii) the root mean squared error between the percent density (PMD) as measured by the machinery and the radiologist.

Best results are obtained with T_{dense} in the interval 0.70-0.80. In the remainder of the Example results are therefore reported with T_{dense} set to 0.75.

Table 1 summarizes the results on the density dataset. Reported are (i) the Pearson correlation coefficient (and 95% CI) between PMD as measured by the machinery and the radiologist, (ii-iii) the image-wise average (±standard deviation) of the Dice coefficient for both dense and fatty tissue, and (iv) the average percent density (±standard deviation).

FIG. 3 shows an example of a mammogram, the corresponding Cumulus-like segmentation and the segmentation obtained with the CSAE that incorporates the sparsity term described herein for use in the invention.

TABLE 1
Comparison of automated with radiologist's
MD scores for the density dataset.

| | |
|---|---|
| R_{PMD}_{_{CSAE}}_{-PMD}_{_{Rad}} | 0.85 (0.83-0.88) |
| Dice_{dense} | 0.63 ± 0.19 |
| Dice_{fat} | 0.95 ± 0.05 |
| PMD | 0.16 ± 0.11 |

The initial output of the MT scoring is a score that represents the posterior probability that a given pixel belongs to the “cancer” class. To obtain one MT score per image, the posteriors of 500 patches randomly sampled from the breast area were averaged.

MT scoring performance of the three training regimes was evaluated on the Dutch Breast Cancer Screening Dataset for each of the three corresponding tasks: i) separating (future) cancers from controls, ii) separating healthy controls from interval cancers, and iii) separating screen-detected cancers from interval cancers. All classifiers were trained using 5-fold cross-validation to support training and validating on the same dataset in an unbiased fashion.

Table 2 summarizes the results in terms of AUCs—the area under the receiver operating characteristic (ROC) curve—and their 95% confidence intervals (CIs). AUCs larger than 0.5 in combination with confidence intervals that do not include 0.5 demonstrate statistically significant separation of the two groups. In summary, the classifiers for each of three training regimes achieve significant separation when evaluated on each the three corresponding separation tasks. Training regime i) achieves the best results (although not significantly so) for all three tasks.

TABLE 2
The area under the receiver operating characteristic curve (AUC) for
posteriors based on each of the three training regimes validated on
each of three corresponding task (using 5-fold cross-validation).

Train-

| ing | AUC (95% CIs) | | |
|---|---|---|---|
| regime | H vs (SD + I) | H vs I | SD vs I |
| i | 0.569 (0.536-0.601) | 0.629 (0.571-0.687) | 0.591 (0.531-0.652) |
| ii | 0.576 (0.543-0.608) | 0.645 (0.589-0.702) | 0.596 (0.537-0.655) |
| iii | 0.566 (0.534-0.590) | 0.633 (0.577-0.690) | 0.584 (0.525-0.643) |

We also evaluated the ability of volumetric mammographic density (using Volpara) to separate the two classes for each of the three tasks. The corresponding AUCs are summarized in Table 3. The separation of the two classes for each of the three regimes was also statistically significant for volumetric density and in terms of AUCs very similar to the trained texture classifiers.

TABLE 3
The area under the receiver operating characteristic curve (AUC) for
volumetric density (Volpara) validated on each of three tasks.

| | AUC (95% CIs) | | |
|---|---|---|---|
| | H vs (SD + I) | H vs I | SD vs I |
| MD | 0.578 (0.546-0.611) | 0.639 (0.581-0.697) | 0.594 (0.534 0.655) |

To investigate to what extent mammographic texture (MT) and mammographic density (MD, Volpara) encode the same or complementary information relative to separating the two classes in each of the three tasks, they were analyzed jointly. Table 4 shows a cross tabulation of MD low/high categories and low/high categories of MT scores for training regime i) applied to the task corresponding to regime ii (separating healthy controls from interval cancers—H vs I). The MD and MT categories are defined by the median of each score over the population. Each table element (one per MD/MT category combination) contains the odds ratio (OR) of the number of “cancers” and “controls” falling in that low/high combination. ORs are calculated using low MD, low MT as reference category.

Table 4 demonstrates that within density categories, the texture score manages to stratify risk showing higher ORs for high texture compared to low texture—although only with borderline statistical significance due to the low number of available cancers.

Table 5 gives the same cross-tabulation but using training regime 2 (H vs I) instead of 1—still evaluated on H vs I. The same pattern as above is repeated but interestingly, the OR for MD low, MT high is higher than the OR for MD high, MT low—although not significantly so.

Table 6 gives the same cross-tabulation but using training regime 4 (SD vs I) instead of 1—still evaluated on H vs I. The pattern from Table 5 is repeated although the difference between MD low, MT high and MT low, MD high is smaller.

TABLE 4
Training regime 1, H vs (SD + I) in combination
with MD - reported results on H vs I

ORs (95% CIs)
#controls/#cases

| | MD low | MD high |
|---|---|---|
| MT high | 1.24 (0.51-3.00) | 2.94 (1.72-5.01) |
| | 36/8 | 127/67 |
| MT low | REF | 1.70 (0.76-3.82) |
| | 128/23 | 36/11 |

TABLE 5
Training regime 2, H vs I in combination
with MD - reported results on H vs I

ORs (95% CIs)
#controls/#cases

| | MD low | MD high |
|---|---|---|
| MT high | 2.13 (0.91-4.98) | 3.36 (1.95-5.78) |
| | 30/10 | 133/70 |
| MT low | REF | 1.70 (0.69-4.21) |
| | 134/21 | 30/8 |

TABLE 6
Training regime 3, SD vs I in combination
with MD - reported results on H vs I

ORs (95% CIs)
#controls/#cases

| | MD low | MD high |
|---|---|---|
| MT high | 1.96 (0.84-4.58) | 3.31 (1.92-5.71) |
| | 32/10 | 131/69 |
| MT low | REF | 1.77 (0.74-4.22) |
| | 132/21 | 32/9 |

Initially, it is noted that the automated PMD scores have a very strong positive relationship with the manual Cumulus scores (R=0.85—Table 1, line 1) and are competitive with reported correlation coefficients from the literature, e.g., 0.63 [61], 0.70 [12], 0.85 [15], 0.88 [14] and 0.91 [10].

Furthermore, measures of mammographic density (MD) (Table 3) and mammographic texture (MT) (Table 2) are seen both to associate positively with the risk that a woman will develop breast cancer that will not be detected during regular screening mammography—through test regimes ii) H vs I and iii) SD vs I For MD, this is a validation of a previously reported results [68], for MT this is not previously reported. It is further shown that the suggested training regimes i)-iii) for MT, all associate positively with said risk.

The training regime H vs I afforded the best risk segregation on all three test setups (Table 2).

It was also demonstrated that MT complimented MD in the sense that stratification according to MT low/high categories within a fixed density category yielded increasing risk for increasing MT score (Tables 4-6). Furthermore, the results indicate that the combination of a low MD and high MT category may yield a higher risk than low MT, high MD—for two of three training regimes. This demonstrates that MT “unfolds” the density axis through a measure of tissue composition (MT) and makes more informed stratification strategies possible. This is clinically important, as, the current stratification strategy of choice is to offer women with high MD enhanced screening using secondary and more sensitive modalities such as ultrasound and MRI. The present results indicate that making that choice on MD alone will both miss some women at high risk and also needlessly refer some women who are at lower risk than MD suggests. The former gives women at risk sub-optimal screening and the latter will cause unnecessary anxiety. An example of a mammogram exhibiting a high textural masking risk but a low density masking risk is seen in FIG. 4.

Although the presented results are promising, they do not necessarily reveal the full potential of MT based risk of missing cancers during mammography. The two training setups specifically designed for said risk, H vs I and SD vs I share the common simplifying assumption that interval cancers are a good surrogate for masked or missed cancers and is thus confounded by both rapidly growing cancers and human error during mammography diagnosis.

In that sense, a more ideal training setup would be the following:
1) Healthy controls that are screen negative using both standard mammography and a secondary modality of choice, say, MRI.
2) Masked cancers that are screen negative using mammography but where a cancer is diagnosed using MRI and subsequently confirmed through biopsy.

Using the screen negative mammograms of the above two groups to train the framework described in the present work, would result in a classifier that would yield a true MT masking posterior for screen negative mammograms and MRI. Unfortunately, such datasets are not readily available at this time.

### REFERENCES

[1] A. Jemal, F. Bray, M. M. Center, J. Ferlay, E. Ward, and D. Forman, “Global cancer statistics,” CA Cancer J Clin, vol. 61, pp. 69-90, 2011. [Online]. Available: http://dx.doi.org/10.3322/caac.20107
[2] J. Ferlay, E. Steliarova-Foucher, J. Lortet-Tieulent, S. Rosso, J. W. W. Coebergh, H. Comber, D. Forman, and F. Bray, “Cancer incidence and mortality patterns in europe: estimates for 40 countries in 2012,” Eur J Cancer, vol. 49, pp. 1374-1403, 2013. [Online]. Available: http://dx.doi.org/10.1016/j.ejca.2012.12.027
[3] I. T. Gram, E. Funkhouser, and L. Taba'r, “The taba'r classification of mammographic parenchymal patterns,” Eur J Radiol, vol. 24, pp. 131-136, 1997.
[4] V. McCormack and I. dos Santos Silva, “Breast density and parenchymal patterns as markers of breast cancer risk: a meta-analysis,” Cancer Epidemiol Biomarkers Prev, vol. 15, pp. 1159-1169, 2006.
[5] N. F. Boyd, L. J. Martin, M. Bronskill, M. J. Yaffe, N. Duric, and S. Minkin, “Breast tissue composition and susceptibility to breast cancer,” J Natl Cancer Inst, vol. 102, pp. 1224-1237, 2010. [Online]. Available: http://dx.doi.org/10.1093/jnci/djq239
[6] J. Cuzick, J. Warwick, E. Pinney, S. W. Duffy, S. Cawthorn, A. Howell, J. F. Forbes, and R. M. Warren, “Tamoxifen-induced reduction in mammographic density and breast cancer risk reduction: a nested case-control study,” Journal of the National Cancer Institute, vol. 103, no. 9, pp. 744-752, 2011.
[7] J. N. Wolfe, “Risk for breast cancer development determined by mammographic parenchymal pattern,” Cancer, vol. 37, pp. 2486-2492, 1976.
[8] L. Taba'r, S. W. Duffy, B. Vitak, H.-H. Chen, and T. C. Prevost, “The natural history of breast carcinoma,” Cancer, vol. 86, no. 3, pp. 449-462, 1999.
[9] J. W. Byng, N. F. Boyd, E. Fishell, R. A. Jong, and M. J. Yaffe, “The quantitative analysis of mammographic densities,” Phys Med Biol, vol. 39, pp. 1629-1638, 1994.
[10] M. G. Kallenberg, M. Lokate, C. H. van Gils, and N. Karssemeijer, “Automatic breast density segmentation: an integration of different approaches,” Phys Med Biol, vol. 56, pp. 2715-2729, 2011.
[11] S. Petroudi, T. Kadir, and M. Brady, “Automatic classification of mammographic parenchymal patterns: A statistical approach,” in Engineering in Medicine and Biology Society, 2003. Proceedings of the 25th Annual International Conference of the IEEE, vol. 1. IEEE, 2003, pp. 798-801.
[12] J. J. Heine, M. J. Carston, C. G. Scott, K. R. Brandt, F.-F. Wu, V. S. Pankratz, T. A. Sellers, and C. M. Vachon, “An automated approach for estimation of breast density,” Cancer Epidemiol Biomarkers Prev, vol. 17, pp. 3090-3097, 2008.
[13] A. Oliver, X. Llado, R. Marti, J. Freixenet, and R. Zwiggelaar, “Classifying mammograms using texture information,” in Medical Image Understanding and Analysis, 2007, pp. 223-227.
[14] J. Li, L. Szekely, L. Eriksson, B. Heddson, A. Sundbom, K. Czene, P. Hall, and K. Humphreys, “High-throughput mammographic-density measurement: a tool for risk prediction of breast cancer,” Breast Cancer Res, vol. 14, p. R114, 2012.
[15] B. M. Keller, D. L. Nathan, Y. Wang, Y. Zheng, J. C. Gee, E. F. Conant, and D. Kontos, “Estimation of breast percent density in raw and processed full field digital mammography images via adaptive fuzzy c-means clustering and support vector machine segmentation,” Med Phys, vol. 39, no. 8, pp. 4903-4917, 2012.
[16] H. Li, M. L. Giger, O. I. Olopade, and M. R. Chinander, “Power spectral analysis of mammographic parenchymal patterns for breast cancer risk assessment,” J Digit Imaging, vol. 21, pp. 145-152, 2008.
[17] A. Manduca, M. Carston, J. Heine, C. Scott, V. Pankratz, K. Brandt, T. Sellers, C. Vachon, and J. Cerhan, “Texture features from mammographic images and risk of breast cancer,” Cancer Epidemiol Biomarkers Prev, vol. 18, pp. 837-845, 2009. [Online]. Available: http://dx.doi.org/10.1158/1055-9965.EPI-08-0631
[18] L. Ha'berle, F. Wagner, P. A. Fasching, S. M. Jud, K. Heusinger, C. R. Loehberg, A. Hein, C. M. Bayer, C. C. Hack, M. P. Lux et al., “Characterizing mammographic images by using generic texture features,” Breast Cancer Res, vol. 14, no. 2, p. R59, 2012.
[19] M. Nielsen, G. Karemore, M. Loog, J. Raundahl, N. Karssemeijer, J. D. M. Otten, M. A. Karsdal, C. M. Vachon, and C. Christiansen, “A novel and automatic mammographic texture resemblance marker is an independent risk factor for breast cancer,” Cancer Epidemiol, vol. 35, pp. 381-387, 2011.
[20] J. J. Heine, C. G. Scott, T. A. Sellers, K. R. Brandt, D. J. Serie, F.-F. Wu, M. J. Morton, B. A. Schueler, F. J. Couch, J. E. Olson, V. S. Pankratz, and C. M. Vachon, “A novel automated mammographic density measure and breast cancer risk,” J Natl Cancer Inst, vol. 104, pp. 1028-1037, 2012. [Online]. Available: http://dx.doi.org/10.1093/jnci/djs254
[21] M. Nielsen, C. M. Vachon, C. G. Scott, K. Chernoff, G. Karemore, N. Karssemeijer, M. Lillholm, and M. A. Karsdal, “Mammographic texture resemblance generalizes as an independent risk factor for breast cancer,” Breast Cancer Res, vol. 16, p. R37, 2014. [Online]. Available: http://dx.doi.org/10.1186/bcr3641
[22] Y. Zheng, B. M. Keller, S. Ray, Y. Wang, E. F. Conant, J. C. Gee, and D. Kontos, “Parenchymal texture analysis in digital mammography: A fully automated pipeline for breast cancer risk assessment,” Med Phys, vol. 42, no. 7, pp. 4149-4160, 2015.
[23] M. Ranzato, C. S. Poultney, S. Chopra, and Y. LeCun, “Efficient learning of sparse representations with an energy-based model,” in Advances in Neural Information Processing Systems, 2007, pp. 1137-1144.
[24] M. Ranzato, F. J. Huang, Y.-L. Boureau, and Y. LeCun, “Unsupervised learning of invariant feature hierarchies with applications to object recognition,” in Computer Vision and Pattern Recognition, 2007. CVPR'07. IEEE Conference on. IEEE, 2007, pp. 1-8.
[25] K. Petersen, K. Chernoff, M. Nielsen, and A. Ng, “Breast density scoring with multiscale denoising autoencoders,” in Proc. Sparsity Techniques in Medical Imaging 2012, in conjunction with MICCAI 2012, 2012.
[26] K. Petersen, M. Nielsen, P. Diao, N. Karssemeijer, and M. Lillholm, “Breast tissue segmentation and mammographic risk scoring using deep learning,” in Breast Imaging: 12th International Workshop, IWDM 2014, ser. Lecture Notes in Computer Science, H. Fujita, T. Hara, and C. Muramatsu, Eds. Springer, 2014, vol. 8539, pp. 88-94.
[35] Y. Bengio, A. Courville, and P. Vincent, “Representation learning: A review and new perspectives,” Pattern Analysis and Machine Intelligence, IEEE Transactions on, vol. 35, no. 8, pp. 1798-1828, 2013.
[36] J. Schmidhuber, “Deep learning in neural networks: An overview,” Neural Networks, vol. 61, pp. 85-117, 2015.
[37] Y. Bengio, “Learning deep architectures for AI,” Foundations and Trends® in Machine Learning, vol. 2, no. 1, pp. 1-127, 2009.
[38] Y. Lecun, L. Bottou, Y. Bengio, and P. Haffner, “Gradient-based learning applied to document recognition,” Proceedings of the IEEE, vol. 86, pp. 2278-2324, 1998. [Online]. Available: http://ieeexplore.ieee.org/stamp/stamp.jsp?arnumber=726791
[39] C. Farabet, C. Couprie, L. Najman, and Y. LeCun, “Learning hierarchical features for scene labeling,” Pattern Analysis and Machine Intelligence, IEEE Transactions on, vol. 35, pp. 1915-1929, 2013.
[40] F. Ning, D. Delhomme, Y. LeCun, F. Piano, L. Bottou, and P. E. Barbano, “Toward automatic phenotyping of developing embryos from videos,” Image Processing, IEEE Transactions on, vol. 14, no. 9, pp. 1360-1371, 2005.
[41] D. Ciresan, A. Giusti, L. M. Gambardella, and J. Schmidhuber, “Deep neural networks segment neuronal membranes in electron microscopy images,” in Advances in Neural Information Processing Systems, 2012, pp. 2843-2851.
[42] S. C. Turaga, J. F. Murray, V. Jain, F. Roth, M. Helmstaedter, K. Briggman, W. Denk, and H. S. Seung, “Convolutional networks can learn to generate affinity graphs for image segmentation,” Neural Computation, vol. 22, no. 2, pp. 511-538, 2010.
[43] D. Wei, B. Sahiner, H. Chan, and N. Petrick, “Detection of masses on mammograms using a convolutional neural network,” in Acoustic, Speech and Signal Processing, vol. 5, 1995, pp. 3483-3486,
[44] P. Fonseca, J. Mendoza, J. Wainer, J. Ferrer, J. Pinto, J. Guerrero, and B. Castaneda, “Automatic breast density classification using a convolutional neural network architecture search procedure,” in SPIE Medical Imaging. International Society for Optics and Photonics, 2015, pp. 941 428-941 428.
[45] A. R. Jamieson, R. Alam, and M. L. Giger, “Exploring deep parametric embeddings for breast cadx,” in SPIE Medical Imaging. International Society for Optics and Photonics, 2011, pp. 79 630Y-79 630Y.
[46] A. R. Jamieson, K. Drukker, and M. L. Giger, “Breast image feature learning with adaptive deconvolutional networks,” in SPIE Medical Imaging. International Society for Optics and Photonics, 2012, pp. 831 506-831 506.
[47] V. Jain, J. F. Murray, F. Roth, S. Turaga, V. Zhigulin, K. L. Briggman, M. N. Helmstaedter, W. Denk, and H. S. Seung, “Supervised learning of image restoration with convolutional networks,” in Computer Vision, 2007. ICCV 2007. IEEE 11th International Conference on. IEEE, 2007, pp. 1-8.
[48] G. E. Hinton and R. R. Salakhutdinov, “Reducing the dimensionality of data with neural networks,” Science, vol. 313, pp. 504-507, 2006.
[49] G. E. Hinton, “Learning multiple layers of representation,” Trends in cognitive sciences, vol. 11, no. 10, pp. 428-434, 2007.
[50] P. Vincent, H. Larochelle, Y. Bengio, and P. A. Manzagol, “Extracting and composing robust features with denoising autoencoders,” in International Conference on Machine Learning, 2008, pp. 1096-1103.
[51] J. Masci, U. Meier, D. Ciresan, and J. Schmidhuber, “Stacked convolutional auto-encoders for hierarchical feature extraction,” in Artificial Neural Networks and Machine Learning—ICANN 2011. Springer, 2011, pp. 52-59.
[52] Q. Le, M. Ranzato, R. Monga, M. Devin, K. Chen, G. Corrado, J. Dean, and A. Ng, “Building high-level features using large scale unsupervised learning,” in International Conference in Machine Learning, 2012.
[53] T. Lindeberg, Scale-Space Theory in Computer Vision. Dordrecht, the Netherlands: Kluwer Academic Publishers, 1994.
[54] L. Florack, “A spatio-frequency trade-off scale for scale-space filtering,” Pattern Analysis and Machine Intelligence, IEEE Transactions on, vol. 22, no. 9, pp. 1050-1055, 2000.
[55] B. A. Olshausen et al., “Emergence of simple-cell receptive field properties by learning a sparse code for natural images,” Nature, vol. 381, no. 6583, pp. 607-609, 1996.
[56] H. Lee, C. Ekanadham, and A. Y. Ng, “Sparse deep belief net model for visual area V2,” in Advances in Neural Information Processing Systems, 2008, pp. 873-880.
[57] V. Nair and G. E. Hinton, “Rectified linear units improve restricted Boltzmann machines,” in International Conference on Machine Learning, 2010, pp. 807-814.
[59] G. Montavon, G. Orr, and M. K, Eds., Neural Networks: Tricks of the Trade. Springer, 2012, vol. 7700.
[61] C. Nickson, Y. Arzhaeva, Z. Aitken, T. Elgindy, M. Buckley, M. Li, D. R. English, and A. M. Kavanagh, “Autodensity: an automated method to measure mammographic breast density that predicts breast cancer risk and screening outcomes.” Breast Cancer Res, vol. 15, no. 5, p. R80, 2013. [Online]. Available: http://dx.doi.org/10.1186/bcr3474
[66] A. Droniou and O. Sigaud, “Gated autoencoders with tied input weights,” in International Conference on Machine Learning, 2013, pp. 154-162.
[67] A. Coates, “Demystifying unsupervised feature learning,” Ph.D. dissertation, Stanford University, 2012.
[68] Carney P A, Miglioretti D L, Yankaskas B C, Kerlikowske K, Rosenberg R, Rutter C M, Geller B M, Abraham L A, Taplin S H, Dignan M, Cutter G. “Individual and combined effects of age, breast density, and hormone replacement therapy use on the accuracy of screening mammography,” Annals of internal medicine. 138(3):168-75, 2003

1. A method of computer image analysis of a mammogram image in which no potential cancer lesion is visually observable, said method serving to determine the risk of there being such a lesion physically present or about to arise within a screening interval, said method comprising applying to the image a statistical classifier trained to score on the basis of texture features in the image that reflect such risk.

2. A method as claimed in claim 1, wherein the classifier has been trained to discriminate between (a) mammogram images in which no potential cancer lesion is visually observable which belong to patients who go on to remain free from breast cancer over a period after their said mammogram image was obtained, and (b) mammogram images in which no potential cancer lesion is visually observable which belong to patients who are later diagnosed with breast cancer within a similar period.

3. A method as claimed in claim 2, wherein the cancer diagnosis relating to the images in group (b) has been based on the detection of interval cancers.

4. A method as claimed in claim 2, wherein the cancer diagnosis relating to the images in group (b) has been based on the detection of cancer in a subsequent regular screening mammogram.

5. A method as claimed in claim 2, wherein the cancer diagnosis relating to the images in group (b) has been based on the detection of cancer in some cases based on the detection of interval cancers and in some cases in a subsequent regular screening mammogram.

6. A method as claimed in claim 1, wherein the classifier has been trained to discriminate between (a) mammogram images in which no potential cancer lesion is visually observable which belong to patients who go on to be diagnosed with breast cancer at a subsequent regular mammogram screening, and (b) mammogram images in which no potential cancer lesion is visually observable which belong to patients who are later diagnosed with an interval breast cancer.

7. A method as claimed in claim 1, wherein the classifier has been trained to discriminate between (a) mammogram images in which no potential cancer lesion is visually observable which belong to patients who have been subject to further investigation by more sensitive detection methods than mammogram screening without any breast cancer being observed, and (b) mammogram images in which no potential cancer lesion is visually observable which belong to patients who have been subject to further investigation by more sensitive detection methods than mammogram screening with the result that a breast cancer has then been observed.

8. A method as claimed in claim 1, wherein to apply the classifier to the mammogram image, a feature representation based on texture features is extracted from the image, said feature representation having been learnt in the training of the classifier.

9. A method as claimed in claim 8, wherein the classifier is a neural network having at least two convolutional layers.

10. A method as claimed in claim 9, wherein the classifier has a multinomial logistic regression further layer which maps a said feature representation obtained in the last of the at least two convolutional layers into label space.

11. A method as claimed in claim 8, wherein the feature representation has been learnt by learning respective feature representations in said convolutional layers by unsupervised learning using a sparse autoencoder combining population sparsity and lifetime sparsity as a sparsity regulariser and by encoding said features to learn a sparse overcomplete feature representation of the training images.

12. A method as claimed in claim 8, wherein said training images are labelled as cancer or control.

13. A method of computer image analysis of a mammogram image in which no potential cancer lesion is visually observable, wherein a composite measure of the risk of there being a lesion physically present despite no potential cancer lesion being visually observable in said mammogram image is obtained by combining the risk of there being such a lesion physically present determined as claimed in claim 1 with a measure of risk based on mammographic density scoring of the mammogram.

14. A method as claimed in claim 13, wherein to obtain said measure of risk based on mammographic density scoring of the mammogram a trained classifier is applied to the mammogram.

15. A method as claimed in claim 14, wherein to apply the classifier to the mammogram image, a feature representation based on density features is extracted from the image, said feature representation having been learnt in the training of the classifier.

16. A method as claimed in claim 15, wherein the classifier is a neural network having at least two convolutional layers.

17. A method as claimed in claim 16, wherein the classifier has a multinomial logistic regression further layer which maps a said feature representation obtained in the last of the at least two convolutional layers into label space.

18. A method as claimed in claim 15, wherein the feature representation has been learnt by learning respective feature representations in said convolutional layers by unsupervised learning using a sparse autoencoder combining population sparsity and lifetime sparsity as a sparsity regulariser and by encoding said features to learn a sparse overcomplete feature representation of the training images.

19. A method as claimed in claim 15, wherein pixels of said training images are labelled as fatty tissue or dense tissue.

20. A method as claimed in claim 1, further comprising outputting a determined risk of there being a cancer lesion physically present or about to arise within a screening interval.

21. A method of screening a population of women for breast cancer by mammography, comprising establishing a screening schedule, conducting a screening mammography on a patient in accordance with said screening schedule to obtain a mammogram image, determining whether a cancer lesion is visually observable in said mammogram image, in the event that no cancer lesion is visually observable in said mammogram image conducting a computer image analysis of the mammogram image in which no potential cancer lesion is visually observable, said method serving to determine the risk of there being such a lesion physically present or about to arise within a screening interval, said method comprising applying to the image a statistical classifier trained to score on the basis of texture features in the image that reflect such risk.

22. A method as claimed in claim 21, wherein said computer image analysis is conducted in accordance with any one of claims 2 to 20.

23. A method as claimed in claim 21, further comprising conducting a further imaging diagnostic investigation of said patient if the determined risk is above a predetermined threshold.

24. A method as claimed in claim 21, further comprising scheduling a further mammogram investigation of said patient in advance of a date for a further mammogram investigation indicated by said screening schedule.

25. A non-transitory computer readable medium encoded with an instruction set for receiving mammogram image data relating to a mammogram in which no cancer lesion is visually observable and conducting a computer image analysis thereof in accordance with claim 1 and outputting a determined risk of there being a cancer lesion physically present or about to arise within a screening interval.

26. A computer comprising a non-transitory computer readable medium encoded with an instruction set for receiving mammogram image data relating to a mammogram in which no cancer lesion is visually observable and conducting a computer image analysis thereof in accordance with claim 1 and outputting a determined risk of there being a cancer lesion physically present or about to arise within a screening interval.
